(19) United States
(12) Patent Application Publication
(10) Pub. No.: US 2025/0055892 A1
(43) Pub. Date: Feb. 13, 2025

(54) METHOD AND APPARATUS FOR ASSESSING PARTICIPATION IN A MULTI-PARTY COMMUNICATION

(71) Applicant: Uniphore Technologies, Inc., Palo Alto, CA (US)

(72) Inventors: Saurabh Saxena, Palo Alto, CA (US); Mario Gomez, Palo Alto, CA (US); James Gibson, Palo Alto, CA (US); Deepankar DAS, Palo Alto, CA (US)

(21) Appl. No.: 18/723,458

(22) PCT Filed: Dec. 23, 2022
(86) PCT No.: PCT/US2022/053909

§ 371 Date: Jun. 23, 2024

Related U.S. Application Data
(60) Provisional application No. 63/293,659, filed on Dec. 23, 2021.

(51) Int. Cl. H04L 65/403

(52) U.S. Cl. CPC H04L 65/403

(57) ABSTRACT

A method and an apparatus for assessing participation in a multi-party communication are provided and the method includes receiving, from multimedia devices corresponding to multiple participants of a multimedia event including a multi-party communication, multi-modal data for each of the multiple participants, the multi-modal data including video data and audio data, where the multimedia devices are remote to the analytics server, extracting, for each of the plurality of participants, vision information from the video data, at least one of tonal information or text information from the audio data, determining a representative participation score (RPS) based on the vision information and the at least one of the tonal information or the text information for each of the plurality of participants for a predefined time interval, and sending at least one of the vision information, the tonal information, the text information, or the RPS for display.

### CROSS-REFERENCE TO RELATED APPLICATION

This application claims priority to the U.S. Provisional Application Ser. No., filed on Dec. 23, 2021, incorporated herein by reference in its entirety.

### FIELD

The present invention relates generally to video and audio processing, and specifically to assessing participation in a multi-party communication.

### BACKGROUND

Several business and non-business meetings are now conducted in a multimedia mode, for example, web-based audio and video conferences including multiple participants. Reviewing such multimedia meetings, in which significant amount of data, for example, different modes of data is available, to identify key information therefrom has proven to be cumbersome and impractical. While there exists a wealth of information regarding various participants in such meetings, it has been difficult to extract meaningful information from such meetings.

Accordingly, there exists a need in the art for techniques for assessing participation in a multi-party communication.

### SUMMARY

The present invention provides a method and an apparatus for assessing participation in a multi-party communication, substantially as shown in and/or described in connection with at least one of the figures, as set forth more completely in the claims. These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an apparatus for assessing participation m a multi-party communication, according to one or more embodiments.

FIG. 2 illustrates the analytics server of FIG. 1, according to one or more embodiments.

FIG. 3 illustrates the user device of FIG. 1, according to one or more embodiments.

FIG. 4 illustrates a method for assessing participation in a multi-party communication, for example, as performed by the apparatus of FIG. 1, according to one or more embodiments.

FIG. 5 illustrates a method for identifying key moments in a multi-party communication, for example, as performed by the apparatus of FIG. 1, according to one or more embodiments.

FIG. 6 illustrates a method for generating hyper-relevant text keyphrases, according to one or more embodiments.

FIG. 7 illustrates a method for identifying impact of hyper-relevant text keyphrases, according to one or more embodiments.

FIG. 8 illustrates a user interface for assessing participation m a multi-party communication, according to one or more embodiments.

FIG. 9 illustrates a user interface for assessing participation m a multi-party communication, according to one or more embodiments.

FIG. 10 illustrates a user interface for assessing participation m a multi-party communication, according to one or more embodiments.

### DETAILED DESCRIPTION

Embodiments of the present invention relate to a method and an apparatus for assessing participation in a multi-party communication, for example, a video conference call between multiple participants. Participation is broadly assessed by assessing the engagement, and the sentiment and/or emotion of the participants, for example, during the call, after the call, and as a group including some or all participants. The conference call video is processed to extract visual or vision data, for example, facial expression analysis data, and the audio is processed to extract tonal data and optionally text data, for example, text transcribed from the speech of the participants. The multiple modes of data from the meeting, viz., vision data, tonal data and optionally text data (multi-modal data) is used, for example, by trained artificial intelligence and/or machine learning (AI/ML) models or algorithmic models, to assess several parameters for each participant. The assessment based on multiple modes of data is then fused or combined on a time scale to generate fused data or a representative participation score (RPS), which includes a score for engagement and a score for sentiment of each participant. The RPS scores are aggregated for each participant for the entire meeting, and for all participants for the entire meeting. In some embodiments, the RPS is computed in real time for each participant based on vison and tonal data for immediate recent data, while after the call, the RPS is computed for each participant based on vision, tonal and text data for the entire meeting. In some embodiments, a list of highly relevant terms is used in conjunction with text data to identify impact on sentiment and/or emotion or engagement of the participants for a particular meeting, or over several meetings with same or different participants. For brevity, sentiment and/or emotion may be referred to collectively as sentiment hereon.

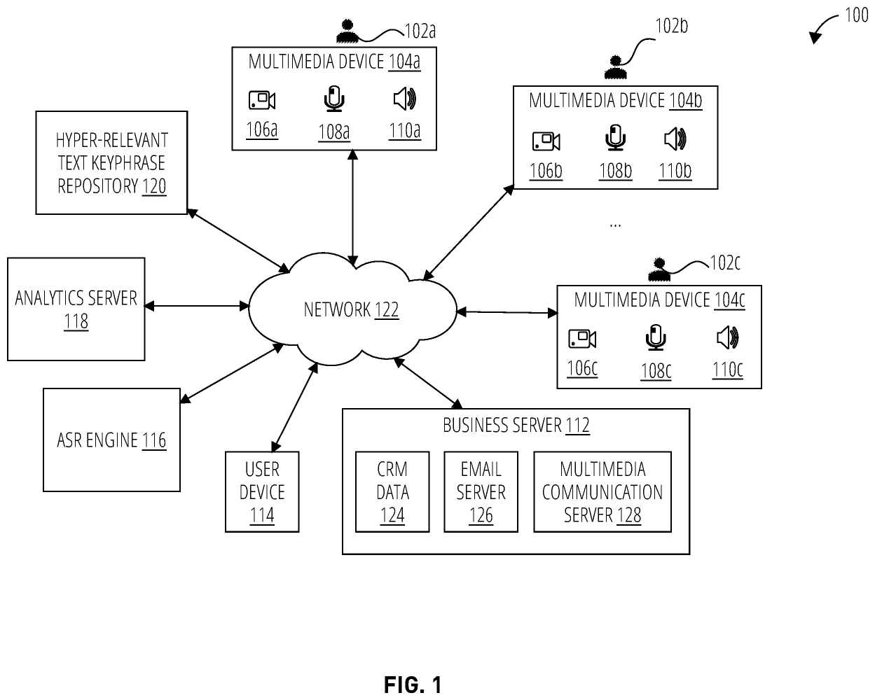

FIG. 1 is a schematic representation of an apparatus 100 for assessing participation in a multi-party communication, according to one or more embodiments of the invention. The apparatus 100 includes a participant 102a of a business in a discussion to the business' customers, for example, the participant 102b and 102c (together referred to by the numeral 102). Each participant 102 is associated with a multimedia device 104a, 104b, 104c (together referred to by the numeral 104) via which each participant communicates with others in the multi-party communication or a meeting. For example, such meetings are enabled by ZOOM VIDEO COMMUNICATIONS, INC. of San Jose, CA, MICROSOFT CORPORATION of Redmond, WA, WEBEX by CISCO Systems of Milpitas, CA, among several other similar web-based or other multimedia/videoconferencing providers. Each of the multimedia devices 104a, 104b, 104c is a computing device, such as a laptop, personal computer, tablet, smartphone or a similar device that includes or is operably coupled to a camera 106a, 106b, 106c, a microphone 108a, 108b, 108c, and a speaker 110a, 110b, 110c, respectively, and additionally includes a graphical user interface (GUI) to display the ongoing meeting, or a concluded meeting, and analytics thereon. In some embodiments, two or more participants 102 may share a multimedia device to participate in the meeting. In such embodiments, the video of the meeting is used for generating the facial expression analysis data, and the audio of the meeting is used to generate tonal and/or text data for all the participants sharing the multimedia device, for example, using techniques known in the art. The apparatus 100 also includes a business server 112, a user device 114, an automatic speech recognition (ASR) engine 116, an analytics server 118 and a hyper-relevant text keyphrase (HRTK) repository 120. Various elements of the apparatus 100 are capable of being communicably coupled via a network 122 or via other communication links as known in the art, and are coupled as and when needed.

The business server 112 provides services such as customer relationship management (CRM), email, multimedia meetings, for example, audio and video meetings to the participants 102, for example, employees of the business and of the business' customer(s). In some embodiments, the business server 112 is configured to use one or more third party services. The business server 112 is configured to extract data, for example, from any of the services it provides, and provide it to other elements of the apparatus 100, for example, the user device 114, the ASR engine or the analytics server 118. For example, the business server 112 may send audio and or video data captured by the multimedia devices 104 to the elements of the apparatus 100.

The user device 114 is an optional device, usable by persons other than the participants 102 to view the meeting with the assessment of the participation generated by the apparatus 100. In some embodiments, the user device 114 is similar to the multimedia devices 104.

The ASR engine 116 is configured to convert speech from the audio of the meeting to text, and can be a commercially available engine or proprietary ASR engines. In some embodiments, the ASR engine 116 is implemented on the analytics server 118.

The analytics server 118 is configured to receive the multi-modal data from the meeting, for example, from the multimedia devices 104 directly or via the business server 112, and process the multi-modal data to determine or assess participation in a meeting.

The HRTK repository 120 is a database of key phrases identified or predefined as relevant to an industry, domain or customers.

The network 122 is a communication Network, such as any of the several communication Networks known in the art, and for example a packet data switching Network such as the Internet, a proprietary Network, a wireless GSM Network, among others.

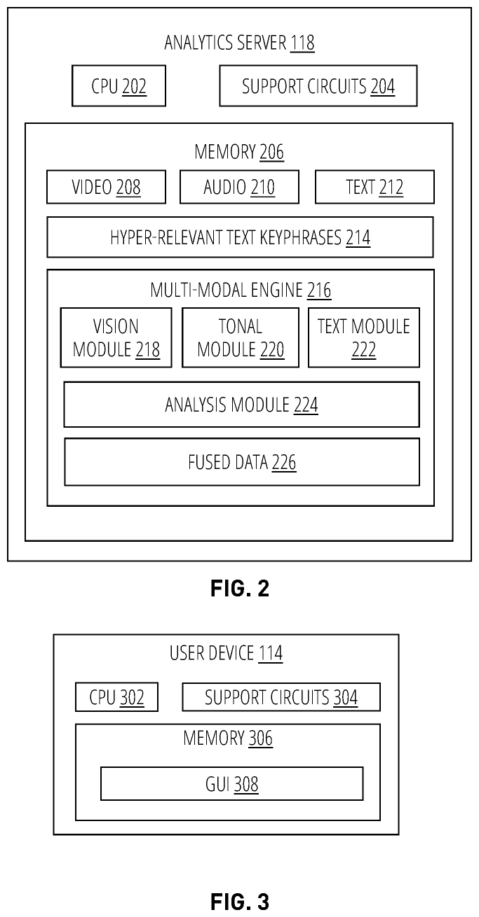

FIG. 2 is a schematic representation of the analytics server 118 of FIG. 1, according to one or more embodiments. The analytics server 118 includes a CPU 202 communicatively coupled to support circuits 204 and a memory 206. The CPU 202 may be any commercially available processor, microprocessor, microcontroller, and the like. The support circuits 204 comprise well-known circuits that provide functionality to the CPU 202, such as, a user interface, clock circuits, network communications, cache, power supplies, I/O circuits, and the like. The memory 206 is any form of digital storage used for storing data and executable software. Such memory includes, but is not limited to, random access memory, read only memory, disk storage, optical storage, and the like. The memory 206 includes computer readable instructions corresponding to an operating system (OS) (not shown), video 208, audio 210 and text 212 corresponding to the meeting. In some embodiments, the text 212 is extracted from the audio 210, for example, by the ASR engine 116. The video 208, the audio 210 and the text 212 (e.g., from ASR engine 116) is available as input, either in real-time or in a passive mode. The memory 206 further includes hyper-relevant text key phrases (HRTKs), for example, obtained from the HRTK repository 120.

The memory 206 includes a multi-modal engine (MME) 216 including a vision module 218, a tonal module 220, a text module 222, an analysis module 224 and fused data 226. Each of the modules 218, 220 and 222 for vision, tonal and text data extract respective characteristics therefrom, and analyzed by the analysis module 224 to generate metrics of participation, for example, engagement and sentiment of the participants, in the meeting. In some embodiments, the analysis module 224 combines the analyzed data from the multiple modes (vision, tonal and optionally text) to generate fused data 226, which is usable to provide one or more representative participation scores for a participant and the meeting, and identify key moments in the meeting. In some embodiments, the analysis module 224 is also configured to generate hyper-relevant text keyphrases for industries, domains or companies, for example, from various public sources.

FIG. 3 is a schematic representation of the user device 114 of FIG. 1, according to one or more embodiments. The user device 114 includes a CPU 302 communicatively coupled to support circuits 304 and a memory 306. The CPU 302 may be any commercially available processor, microprocessor, microcontroller, and the like. The support circuits 304 comprise well-known circuits that provide functionality to the CPU 302, such as, a user interface, clock circuits, network communications, cache, power supplies, I/O circuits, and the like. The memory 306 is any form of digital storage used for storing data and executable software. Such memory includes, but is not limited to, random access memory, read only memory, disk storage, optical storage, and the like. The memory 306 includes computer readable instructions corresponding to an operating system (OS) (not shown), and a graphical user interface (GUI) 308 to display one or more of a live or recorded meeting, and analytics with respect to participation thereon or separately. The user device 114 is usable by persons other than participants 102 while the meeting Is ongoing or after the meeting is concluded. In some embodiments, the multimedia devices 104 are similar to the user device 114 in that each includes a GUI similar to the GUI 308, and each multimedia device also includes a camera, a microphone and a speaker for enabling communication between the participants during the meeting.

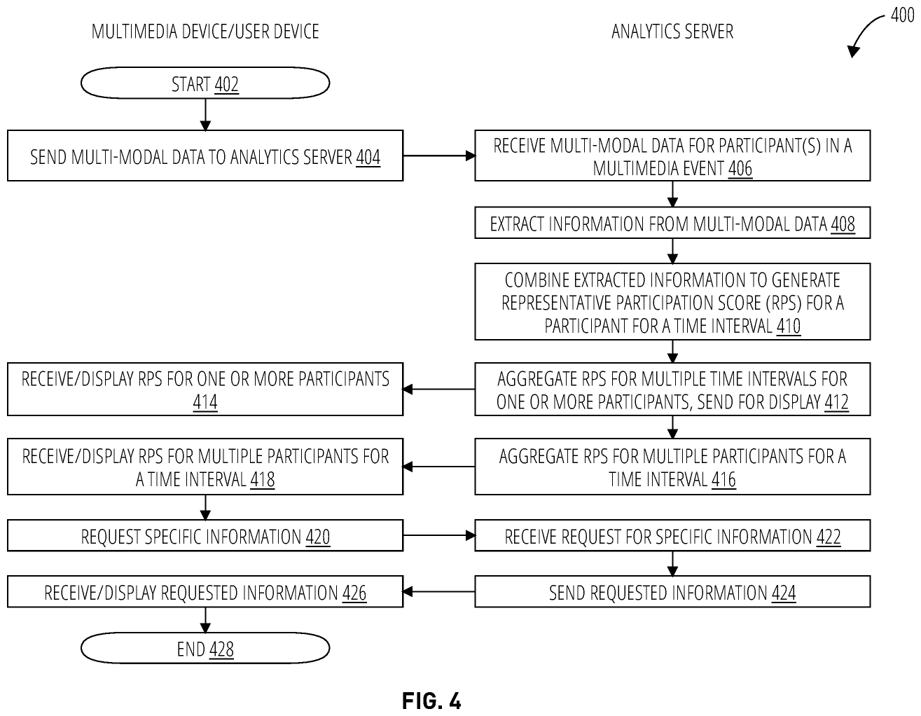

FIG. 4 illustrates a method 400 for assessing participation m a multi-party communication, for example, as performed by the apparatus 100 of FIG. 1, according to one or more embodiments. In some embodiments, steps of the method 400 performed on the analytics server 118 are performed by the MME 216. The method 400 starts at step 402, and proceeds to step 404, at which the multi-modal data (the video and audio data) of the meeting is sent from a multimedia device, for example, one or more of the multimedia devices 104 to the analytics server 118, directly or, for example, via the business server 112. In some embodiments, the multi-modal data is sent live, that is streamed, and in other embodiments, the data is sent in batches of configurable predefined time duration, such as, the entire meeting or short time bursts, for example, 5 seconds.

At step 406, the method 400 receives the multi-modal data for the participant(s) from the multimedia device(s) at the analytics server 118, and at step 408, the method 400 extracts information from each of the multi-modal data. For example, from the video 208 data, the vision module 218 extracts vision parameters for participation for each participant using facial expression analysis and gesture tracking. The parameters include facial expression based sentiments, head nods, disapprovals, among others. From the audio 210 data, the tonal module 220 extracts tonal parameters, which include tone based sentiments, self-awareness parameters such as empathy, politeness, speaking rate, talk ratio, talk over ratio, among others. From the text 212 data, obtained using the audio 210 data by the ASR engine 116, the text module 222 extracts text parameters, which include text-derived sentiments, among others. Sentiments extracted from any of the modes include one or more of happiness, surprise, anger, disgust, sadness, fear, among others.

In some embodiments, extraction of the vision, tonal and text parameters is performed using known techniques. For example, the facial expression analysis and gesture tracking is performed by the vision module 218 by tracking a fixed number of points on each face in each video frame, or a derivative thereof, for example, the position of each point in each frame averaged over a second. In some embodiments, 24 frames are captured in each second, and about 200 points on the face are tracked in each frame, the position of which may be averaged for a second to determine an average value of such points for a second. This facial expression analysis data is used as input by the vision module 218 to determine the vision parameters. In some embodiments, the vision module 218 includes one or more AI/ML models to generate an output of the vision parameters. The AI/ML model(s) of vision module 218 is/are trained using several images of faces and sentiment(s) associated therewith, using known techniques, which enables the vision module 218 to predict or determine the sentiments for an input image of the face for each participant 102. In some embodiments, the vision module 218 includes a finite computational model for determining a sentiment of a participant based on an input image of the face of each participant 102. In some embodiments, the vision module 218 includes a combination of one or more AI/ML models and/or finite computation models. The tonal module 220 analyzes the waveform input of the audio 210 to determine the tonal parameters. The tonal module 220 may include AI/ML models, computational models or both. The text module 222 analyzes the text 212 to determine text parameters, and includes sentiment analyzers as generally known in the art.

In some embodiments, each of the models 218, 220, 222 are configured to determine parameters for the same time interval on the time scale of the meeting. In some embodiments, each of the models 218, 220, 222 are configured to generate a score for corresponding parameters. In addition to determining the corresponding parameters, in some embodiments, one or more of the vision module 218, the tonal module 220 and the text module 222 generate a confidence score associated with the determined parameter to indicate a level of confidence or certainty regarding the accuracy of the determined parameter.

The method 400 proceeds to step 410, at which the method 400 combines extracted information to generate representative participation scores (RPS) for a participant for a given time interval. For example, the time interval is a second, and the method 400 generates the RPS for each second of the meeting. In some embodiments, the RPS is a combination of the scores for the vision parameters, the tonal parameters and the text parameters. In some embodiments, the scores for the vision parameters, the tonal parameters and the text parameters are normalized and then averaged to generate participation scores, that is a score for sentiment and a score for engagement, for each participant for each time interval, for example, 1 second. As used herein, participation is assessed by assessing the engagement and/or the sentiment of participants and correspondingly, the RPS include a score for engagement and a score for sentiment. In some embodiments, some parameters are used to compute the score for engagement, while some other parameters for sentiment. The parameters used for engagement may or may not overlap with the parameters used for sentiment. In some embodiments, vision parameters such as head position with respect to a camera and all the landmark points on the face near the eye are used to determine engagement score, while other landmark points around the eye and cheeks and eyebrows area are used to determine sentiment score.

In some embodiments, the scores for the vision parameters, the tonal parameters and the text parameters are co-normed first and a weighted score is generated for engagement and for sentiment, that is the RPS. In some embodiments, an assessment is made, based on the confidence scores of each of the vision, tonal or text data, as to the certainty thereof, and the weightage of such mode is increased. In some embodiments, the mode having a confidence score below a predefined threshold, or a predefined threshold below the confidence score of other mode is ignored (weight=0). In this manner, the vision, tonal and text data for a predefined time interval of the meeting is combined or fused to generate fused data 226 for the predefined time interval, for example, a second.

At step 412, the method 400 aggregates RPS for multiple time intervals for one participant, for example, a portion of or the entire duration of the meeting. In such instances, the RPS, which includes scores for engagement and/or sentiment represents the engagement levels and/or sentiment of the participant during such time intervals. At step 416, the method 400 aggregates RPS for multiple participants over one or more time intervals, such as a portion of or the entire duration of the meeting. In such instances, the RPS represents the engagement levels and/or the sentiment of the participants for the time intervals. The number of participants, duration and starting point of time intervals is selectable, for example, using a GUI on the multimedia devices 104 or the user device 114. The aggregation may be performed by calculating a simple average over time and/or across participants, or using other statistical techniques known in the art.

One or more of the steps 406-416 discussed above may be performed after the meeting is complete, that is, in a passive mode. In some embodiments, steps 406-412 are performed in real time, that is, as soon as practically possible within the physical constraints of the elements of the apparatus 100, and in such embodiments, only the vision and tonal data is processed, and the text data is not extracted or processed to generate the RPS. Further, the RPS is generated based on a prior short time interval preceding the current moment, for example, the RPS for an instance takes into account previous 5 seconds of vision and tonal data. In this manner, in the real-time mode, the RPS represents a current participation trend of a participant or a group of participants.

In some embodiments, the RPS for one or more participants 102 and/or a group of participants or all participants, for each second, or a portion of the meeting or the entire meeting is sent for display, for example, on the GUI 308 of the user device 114, or the GUI(s) of the multimedia devices, or any other device configured with appropriate permission and communicably coupled to the network 122. At steps 414 or 418, such devices receive and display the RPS on a GUI, for example, in the context of a recorded playback or live streaming of the meeting.

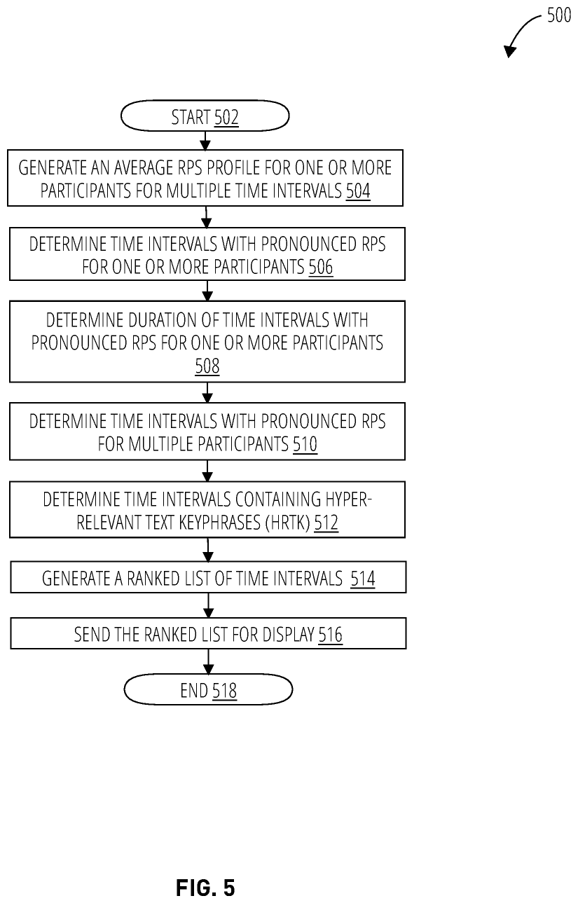

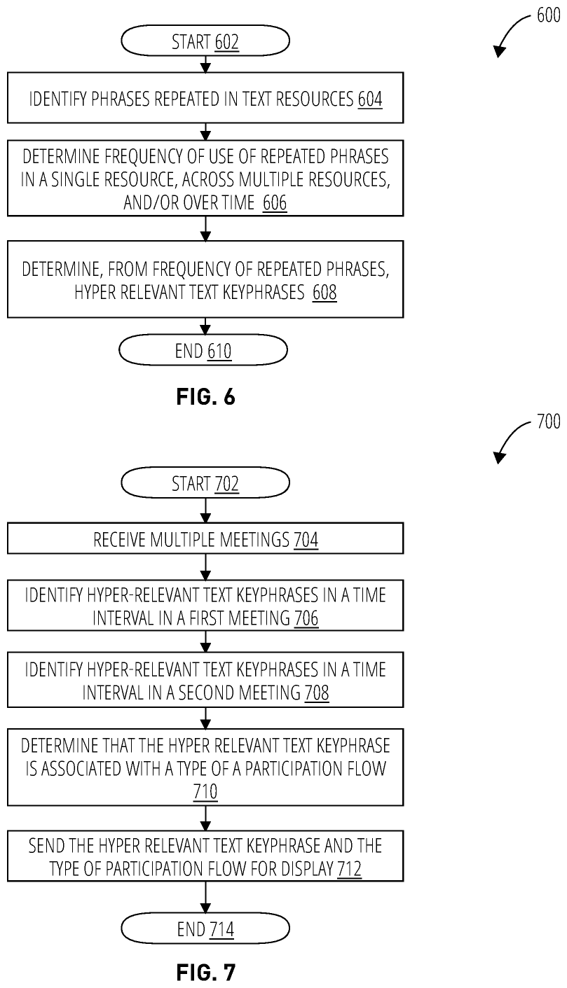

In some embodiments, at step 420, participants or other users may request specific information from the analytics server 118, for example, via the GUI in multimedia devices 104 or the GUI 308 of the user device 114. The specific information may include RPS for specific participant(s) for specific time duration(s), or any other information based on the fused data 226, RPS or constituents thereof, and information based on other techniques, for example, methods of FIG. 5 and FIG. 6. Upon receiving the request at step 422, the analytics server 118 sends the requested information to the requesting device at step 424, which receives and displays the information at step 426. The method 400 proceeds to step 428, at which the method 400 ends.

The techniques discussed herein are usable to identify a customer's participation, a business team's participation or the overall participation. Further, while a business context is used to illustrate an application of techniques discussed herein, the techniques may be applied to several other, non-business contexts.

FIG. 5 illustrates a method 500 for identifying key moments in a multi-party communication, for example, as performed by the apparatus 100 of FIG. 1, according to one or more embodiments. In some embodiments, steps of the method 500 are performed by the MME 216.

The method 500 starts at step 502 and proceeds to step 504, at which the method 500 generates an average RPS profile for one or more participants over a portion of the meeting or the entirety of the meeting, and in some embodiments, the method 500 generates an average RPS profile for each participant for the entirety of the meeting. The average RPS profile represents a baseline sentiment and/or engagement levels of a participant. For example, one participant may naturally be an excited, readily smiling person, while another may naturally have a serious and stable demeanor, and the average RPS profile accounts for the participant's natural sentiment and engagement levels throughout the meeting, and provides a baseline to draw a comparison with.

At step 506, the method 500 identifies or determines time intervals for which RPS of one or more participants has a pronounced movement, for example, time intervals in which the RPS increases or decreases substantively with respect to the average RPS profile for a given participant. A pronounced movement with respect to the average RPS profile indicates a significant change in the sentiment and/or engagement of the participant, and a potentially important time interval(s) in the meeting for that participant. The pronounced movement could be defined as movement in the RPS (difference between the RPS for a moment and the average RPS for a participant) greater than a predefined threshold value.

Steps 504 and 506 help identify important moments for participants based on the participant averaged engagement throughout the meeting. In some embodiments however, the step 504 is not performed, and step 506 determines pronounced movement by comparing a movement of the RPS over time, greater than a predefined threshold. That is, if the RPS of a participant increases (or decreases) more than a predefined threshold value compared to a current RPS within a predefined time interval, for example, 10 seconds, then such time intervals are identified as potentially important time interval(s) for that participant. The time intervals determined at step 506, whether using the averaged RPS score according to step 504 or using absolute movement in the RPS score without using the step 504, are referred to as ‘swings’ in the participation.

At step 508, the method 500 determines the time intervals for which the pronounced movement of the RPS is sustained for one or more participants, for example, for a time duration greater than a predefined threshold. Such time intervals are referred to as ‘profound’ swings.

At step 510, the method 500 determines the time intervals with swings and/or profound swings for multiple participants that overlap or occur at the same time, that is, time intervals in which more than one participant had a pronounced RPS movement, or pronounced RPS movement for a sustained duration of time. Multiple participants having swings and/or pronounced swings in the same or proximate time intervals indicate a mirroring of participation of one or some participant(s) by one or other participant(s). Such time intervals are referred to as ‘mirrored’ swings. Mirrored swings include swings in the RPS of one participant in the same or opposite direction, that is other participants may exhibit similar reaction or opposite reactions to the one participant.

At step 512, the method 500 determines, from time intervals identified at steps 506 (swings), 508 (pronounced swings) and/or step 510 (mirrored swings), the time intervals that contain one or more instances of phrases from a list of predefined phrases that are considered relevant to an industry, domain, company/business or any other parameter. Such phrases are referred to as hyper-relevant text keyphrases (HRTKs) and the time intervals are referred to as blended key moments.

Any of the time intervals identified at steps 506 (swings), 508 (pronounced swings), 510 (mirrored swings) or 512 (blended key moments) are identified as important moments of the meeting, or moments that matter, and at step 514, one or a combination of the swings, pronounced swings, mirrored swings or blended key moments are ranked. In some embodiments, only one type of swings, for example, the pronounced swings, or the mirrored swings or the pronounced and mirrored swings are ranked. Ranking is done according to the quantum of swing, that is, according to the movement of the RPS for the time intervals, cumulated for all or some participants. In some embodiments, the cumulation is performed by summation, averaging, or another statistical model, to arrive at the quantum of movement (or the swing) of the RPS. The time intervals or moments are ranked high if the quantum of the movement of the RPS is high, and lower if the quantum of the movement of the RPS is lower.

At step 516, the method 500 sends the ranked list to a device for display thereon, for example, a device remote to the analytics server 118, such as the multimedia devices or the user device 114. In some instances, the ranked list is sent upon a request received from such a device. The ranked list identifies the portions of the meeting that are considered important. The method 500 proceeds to step 518, at which the method 500 ends.

While the method 500 discusses techniques to identify moments that matter in a single meeting, m some embodiments, blended key moments are identified in moments across different meetings involving the same participants, business or organization, or any other common entity, for example, a customer company treated as an “account” by a provider company selling to the customer company, and a “deal” with the “account” takes several meetings over several months to complete the deal. Blended key moments identified in different meetings held over time are used to identify HRTKs that persistently draw a pronounced or swing reaction from participants. For example, such blended key moments across different meetings are used to identify terms that induced negative, neutral or positive reactions, and based on identification of such terms, propositions that are valuable, factors that were considered negative or low impact, among several other inferences are drawn.

FIG. 6 illustrates a method 600 for generating hyper-relevant text keyphrases, according to one or more embodiments. In some embodiments, the method 600 is performed by the analysis module 224 of FIG. 1, however, in other embodiments, other devices or modules may be utilized to generate the HRTKs, including sourcing HRTKs from third party sources.

The method 600 starts at step 602, and proceeds to step 604, at which the method 600 identifies phrases repeated in one or more text resources, for example, websites, discussion forums, biogs, transcripts of conversations (voice or chat) or other sources of pertinent text. At step 606, the method 600 identifies the frequency of occurrence of such phrases repeated in a single resource across multiple resources, and/or resources made available over time. In step 608, determine, from the frequency of repeated phrases, hyper relevant keyphrases. The method 600 proceeds to step 610, at which the method ends.

In some embodiments, step 604 is performed ongoingly on existing and new text resources to update hyper-relevant text keyphrases (HRTKs) dynamically. In some embodiments, the HRTK repository 120 is updated dynamically after performing step 604, for example, by the analysis modules 224. In some examples, HRTK repository 120 is updated by a third party service, or similar other services.

FIG. 7 illustrates a method 700 for identifying impact of hyper-relevant text keyphrases, for example, as performed by the apparatus 100 of FIG. 1, according to one or more embodiments. In some embodiments, steps of the method 700 are performed by the MME 216. The method 700 starts at step 702, and proceeds to step 704, at which the method 700 receives multiple meetings (recordings thereof), for example, two or more meetings. At step 706, the method 700 identifies time intervals or moments from a first meeting including a hyper relevant text keyphrase (HRTK), and at step 708, the method 700 identifies time intervals or moments from a second meeting, different from the first meeting, including the same HRTK. The first and second meetings may have a common theme, for example, same business, industry, domain, or others, and may or may not have the same participants. Further, in some embodiments, multiple time intervals may be identified in the first and/or the second meeting.

At step 710, the method 700 determines a participation (sentiment and/or engagement) flow (positive, negative, neutral or tending thereto) during the moments identified from the first and the second meetings. For example, if during the identified moments of the first meeting and the second meeting, the participation flow is positive, it is determined that the HRTK is associated with a positive participation flow. Similarly, if during the identified moments of the first meeting and the second meeting, the participation flow is negative or neutral, it is determined that the HRTK is associated with a negative or neutral participation flow, respectively. In case of inconsistent participation flows identified in two or more time intervals associated with the same HRTK, conflict resolution mechanisms are used to arrive at a participation flow. For example, in some embodiments, conflict resolution is based on one or more factors such as recency (selecting a more recent time interval over older one), participant profile (selecting meetings and/or intervals attended by higher profile participants based on job titles), frequency (selecting a keyphrases associated with more of one type of sentiment, and fewer of other type of sentiments, over the keyphrases that are less frequently associate with that kind of sentiment) among others.

At step 712, the method 700 sends the HRTK and the participation flow identified at step 710 for display, for example, to a device remote to the analytics server 118, such as the multimedia devices or the user device 114. In some instances, the HRTK and the participation flow is sent upon a request received from such a device. The method 700 proceeds to step 714, at which the method 700 ends.

In this manner, HRTKs associated with specific type of participation (sentiment/engagement) are identified. Such an identification is usable to change or refine the use of such HRTKs.

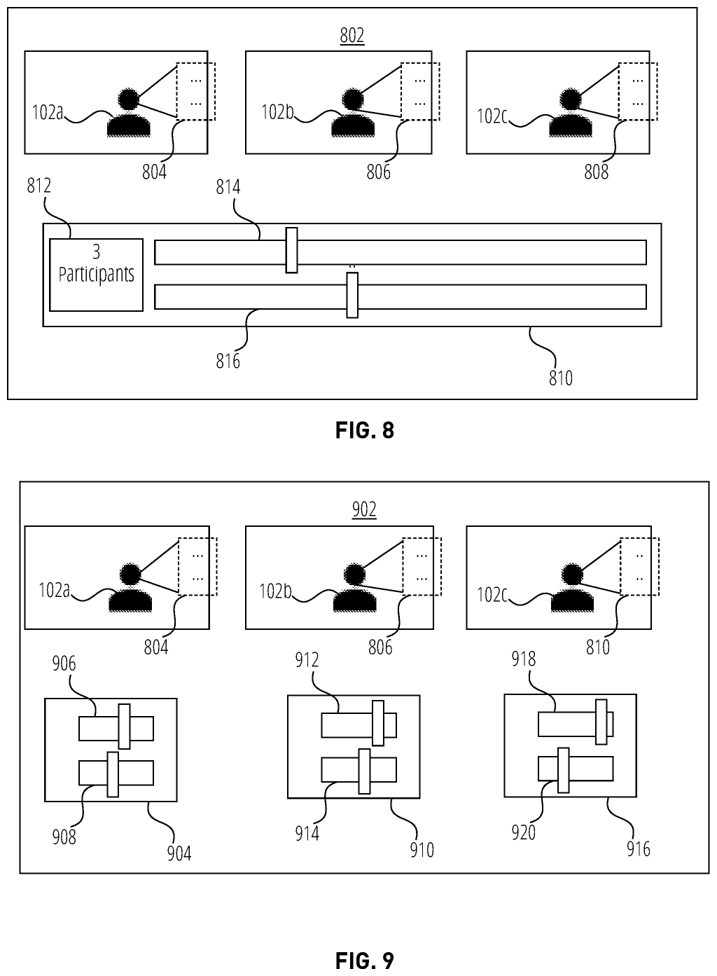

FIG. 8 illustrates a graphical user interface (GUI) 802 displayed on a display of a device, such as a multimedia devices or user device, for assessing participation in a multi-party communication, according to one or more embodiments. The GUI 802 shows participation summary, such as the representative participation scores (RPS), for example, the engagement score and the sentiment score, for each of the participants 102a, 102b, 102c in elements, 804, 806 and 808, respectively. Further, a GUI element 810 shows the cumulative RPS 812 for the meeting, and may include a separate and varying sentiment score 814 and engagement score 816 for the entire meeting. The various inputs for generating the output of the GU I 802 are generated using the techniques discussed above, and are sent to the multimedia devices and/or the user device 114 from the analytics server 118.

Similar to FIG. 8, FIG. 9 illustrates a graphical user interface (GUI) 902 displayed on a display of a device, such as a multimedia devices or user device, for assessing participation in a multi-party communication, according to one or more embodiments. The GUI 902 shows participation summary, such as the representative participation scores (RPS), for example, the engagement score and the sentiment score, for each of the participants 102a, 102b, 102c in elements, 804, 806 and 808, respectively. Further, GUI elements 906 (and 908, 910), 910 (and 912, 914) and 916 (and 918, 920) show the respective sentiment and engagement scores for each of the participants 102a, 102b, 102c, respectively. The various inputs for generating the output of the GUI 902 are generated using the techniques discussed above, and are sent to the multimedia devices and/or the user device 114 from the analytics server 118.

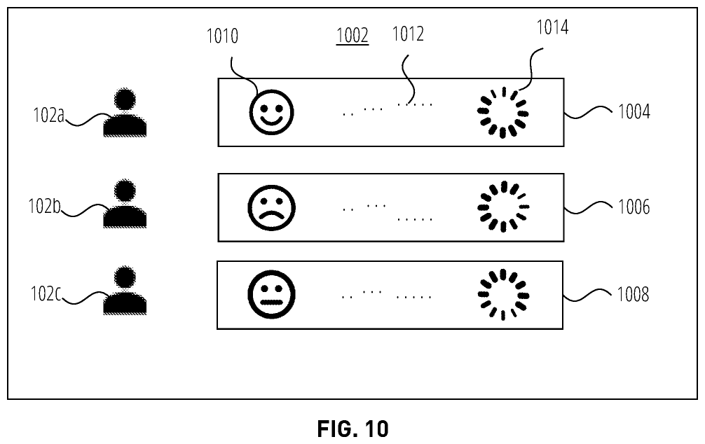

FIG. 10 illustrates a graphical user interface GUI 1002 for assessing participation in a multi-party communication according to one or more embodiments. The GUI 1002 shows summary of participation for each of the participants 102a, 102b, 102c in GUI elements 1004, 1006 and 1008, respectively, after the meeting has concluded. Each of the GUI elements, for example, the GUI element 1004 includes a sentiment score/representation 1010, a sentiment score flow 1012, and an engagement score/representation 1014. The GUI 1002 shows a helpful summary for each participant after the meeting. The various inputs for generating the output of the GUI 1002 are generated using the techniques discussed above, and are sent to the multimedia devices and/or the user device 114 from the analytics server 118.

Several recorded meetings are available over time, and various techniques described herein are further supplemented by cumulated tracking data for each of the participants, organization(s) thereof, a topic (e.g., a deal) of a meeting, keywords, among other unifying themes, in a meeting or across different meetings. Several other graphic representations using the RPS scores and assessment/analysis of participation (sentiment and engagement) performed in real time and/or after conclusion of the meeting are contemplated herein, such as overlaying the RPS scores and/or analysis over a recording or a live streaming playback of the meeting, for moments that matter for a participant, or multiple participants, and for presenting hyper-relevant text key phrases associated with specific sentiments in a meeting or across different meetings. Further, in some embodiments including real time computations, time delays may be introduced in the computation, for example, to perform computation on aggregated data, to present aggregated information, among other factors.

The methods described herein may be implemented m software, hardware, or a combination thereof, in different embodiments. In addition, the order of methods may be changed, and various elements may be added, reordered, combined, omitted or otherwise modified, and some steps may be optional, as apparent from context. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations, and data stores are somewhat arbitrary, and particular operations are illustrated in the context of specific illustrative configurations. Finally, structures and functionality presented as discrete components in the example configurations may be implemented as a combined structure or component. These and other variations, modifications, additions, and improvements may fall within the scope of embodiments as described.

While the foregoing is directed to embodiments of the present invention, other and further embodiments of the invention may be devised without departing from the basic scope thereof.

1. A computing apparatus comprising:
a processor; and
a memory storing instructions that, when executed by the processor, configure the apparatus to:
receive, at an analytics server, from a plurality of multimedia devices corresponding to a plurality of participants of a multimedia event comprising multi-party communication, multi-modal data for each of the plurality of participants, the multi-modal data comprising video data and audio data, wherein the plurality of multimedia devices are remote to the analytics server; and
send, from the analytics server, to a user device or at least one of the plurality of multimedia devices, at least one of vision information, tonal information, text information, or a representative participation score (RPS),
wherein, for each of the plurality of participants, vision information is extracted from the video data, at least one of tonal information or text information from the audio data, and
wherein the RPS is determined based on the vision information and the at least one of the tonal information or the text information, for each of the plurality of participants, for a predefined time interval.

2. The computing apparatus of claim 1, wherein the RPS comprises a sentiment score and an engagement score.

3. The computing apparatus of claim 1, wherein the vision information comprises at least one of sentiments, head nods, or disapprovals, wherein the tonal information comprise s at least one of sentiments, empathy, politeness, speak rate, talk ratio, or talk over ratio, wherein the text information comprises at least one of sentiment, or hyper-relevant text keyphrases (HRTKs).

4. The computing apparatus of claim 1, wherein the RPS is determined by combining the vision information and at least one of tonal information or text information for a given time interval.

5. The computing apparatus of claim 1, wherein the instructions further configure the apparatus to send, from the analytics server, to the user device or the at least one multimedia device, an aggregated RPS for multiple participants for a first time interval.

6. The computing apparatus of claim 1, wherein the instructions further configure the apparatus to send, from the analytics server, to the user device or the at least one multimedia device, aggregated RPS for a single participant for a plurality of consecutive time intervals.

7. A computing apparatus comprising:
a processor; and
a memory storing instructions that, when executed by the processor, configure the apparatus to:
receive, at an analytics server, from a plurality of multimedia devices corresponding to a plurality of participants of a multimedia event comprising a multi-party communication, multi-modal data for each of the plurality of participants, the multi-modal data comprising video data and audio data, wherein the plurality of multimedia devices are remote to the analytics server;
extract, at the analytics server, for each of the plurality of participant s, vision information from the video data, at least one of tonal information or text information from the audio data;
determine, at the analytics server, an aggregated representative participation score (RPS) based on the vision information and the at least one of the tonal information or the text information, for each of the plurality of participants, for a plurality of consecutive time intervals;
determine, at the analytics server, at least one of
a first plurality of time intervals from the plurality of consecutive time intervals, the first plurality of time intervals comprising pronounced RPS for at least one of the plurality of participants,
a second plurality of time intervals from the plurality of consecutive time intervals, the second plurality of time intervals comprising pronounced RPS for at least a predefined duration for at least one of the plurality of participants,
a third plurality of time intervals from the plurality of consecutive time intervals, the third plurality of time intervals comprising pronounced RPS for at least two of the plurality of participants, or
a fourth plurality of time intervals from the plurality of consecutive time intervals, the fourth plurality of time intervals comprising at least one phrase from a predefined set of phrases for at least one of the plurality of participants;
determine, at the analytics server, a ranked list of a plurality of a group of consecutive time intervals comprised in the plurality of consecutive time intervals, based on the aggregated RPS, the at least one of the first plurality of time intervals, the second plurality of time intervals, the third plurality of time intervals, or the fourth plurality of time intervals; and
send, from the analytics server, to a user device or at least one of the plurality of multimedia devices, at least one of the vision information, the tonal information, the text information, the RPS, or the ranked list.

8. The computing apparatus of claim 7, wherein the plurality of consecutive time intervals comprises all time intervals since the beginning of the multimedia event to a current time, and wherein the sending is performed in real time at the end of the plurality of consecutive time intervals.

9. The computing apparatus of claim 7, wherein the instructions further configure the apparatus to:
generate, at the analytics server, a baseline for each of the plurality of participants based on the aggregated RPS; and
adjust, at the analytics server, the at least one of the first plurality of time intervals, the second plurality of time intervals, the third plurality of time intervals, or the fourth plurality of time intervals using the baseline.

10. The computing apparatus of claim 7, wherein the vision information comprises at least one of sentiments, head nods, or disapprovals, wherein the tonal information comprises at least one of sentiments, empathy, politeness, speak rate, talk ratio, or talk over ratio, wherein the text information comprises at least one of sentiment, or hyper-relevant text keyphrases (HRTKs).

11. The computing apparatus of claim 7, wherein the instructions further configure the apparatus to:
identify, at the analytics server, the fourth plurality of time intervals associated with the first plurality of time intervals;
send, from the analytics server, to a user device or at least one of the plurality of multimedia devices, the at least one phrase, and the first plurality of time intervals.

12. A computing apparatus comprising:
a processor; and
a memory storing instructions that, when executed by the processor, configure the apparatus to:
receive, at an analytics server, a first and a second recording of a first and a second multimedia event respectively, each multi-media event comprising multi-party communication, each recording comprising multi-modal data for each of the plurality of participants, the multi-modal data comprising video data and audio data, wherein the plurality of multimedia devices are remote to the analytics server; and
extract, at the analytics server, for each of the plurality of participants, vision information from the video data, at least one of tonal information or text information from the audio data;
determine, at the analytics server, an aggregated representative participation score (RPS) based on the vision information and the at least one of the tonal information or the text information, for each of the plurality of participants, for a plurality of consecutive time intervals;
determine, at the analytics server:
a first time interval from the first record, the first time interval comprising at least one of pronounced RPS for at least one of the plurality of participants, pronounced RPS for at least a predefined duration for at least one of the plurality of participants, or pronounced RPS for at least two of the plurality of participants, and
a second time interval from the second record, the second time interval comprising at least one of pronounced RPS for at least one of the plurality of participants, pronounced RPS for at least a predefined duration for at least one of the plurality of participants, or pronounced RPS for at least two of the plurality of participants;
identify, from the first and the second time intervals, at least one phrase associated with at least one type of participation flow, wherein participation flow types include at least one of positive sentiment, neutral sentiment, negative sentiment, positive engagement, neutral engagement or negative engagement; and
send, from the analytics server, to a user device or at least one of the plurality of multimedia devices, the at least one phrase for display.

13. The computing apparatus of claim 12, wherein the instructions further configure the apparatus to:
generate, at the analytics server, for each of the first recording and the second recording, a baseline for each of the plurality of participants based on the aggregated RPS; and
adjust, at the analytics server, the at first time interval using the baseline of the first recording, and the second time interval using the baseline of the second recording.

14. The computing apparatus of claim 12, wherein the vision information comprises at least one of sentiments, head nods, or disapprovals, wherein the tonal information comprises at least one of sentiments, empathy, politeness, speak rate, talk ratio, or talk over ratio, wherein the text information comprises at least one of sentiment, or hyper-relevant text keyphrases (HRTKs).

15. The computing apparatus of claim 12, wherein the RPS is determined by combining the vision information and at least one of tonal information or text information for a given time interval.
